(19) United States
(12) Patent Application Publication
(10) Pub. No.: US 2004/0261125 A1
(43) Pub. Date: Dec. 23, 2004

(54) Electronic program guide with interactive screen game

(75) Inventors: Michael D. Ellis, Boulder, CO (US); Joel G. Hassell, Arvada, CO (US)

Correspondence Address: FISH & NEAVE LLP, 1251 AVENUE OF THE AMERICAS, 50TH FLOOR, NEW YORK, NY, 10020-1105, US

(73) Assignee: United Video Properties, Inc., Tulsa, OK

(21) Appl. No.: 10/818,937

(22) Filed: Apr. 5, 2004

Related U.S. Application Data
(63) Continuation of application No. 09/140,965, filed on Aug. 27, 1998, now abandoned.

(51) Int. Cl. H04N 7/173; G06F 13/00; H04N 5/445

(52) U.S. Cl. 725/133; 725/40; 725/43; 725/141

(57) ABSTRACT

An interactive screen game system for providing an interactive screen game in a portion of user television equipment. While the screen game is being played, video and audio output from the user television equipment may be allowed to pass to a user. The interactive screen game may be implemented as part of an electronic program guide. The interactive screen game may also be related to the content of the program being viewed. The size and location of the screen game may be adjusted. Advertisements may be shown within the screen game.

### BACKGROUND OF THE INVENTION

This invention relates to television systems, and, more particularly, to the use of interactive games on television systems.

During television commercial breaks, many viewers check program schedules, surf to different channels, or perform other activities unrelated to the current program. This failure to pay attention to the advertisements frustrates advertisers and television executives.

Therefore, it is an object of this invention to keep the viewer interested in the current program, even during television commercial breaks.

### SUMMARY OF THE INVENTION

This and other objects of the invention are accomplished in accordance with the principles of the present invention by providing an interactive screen game system having an interactive screen game on user television equipment. The user television equipment may have at least one remote control and produces an audio and a video output. In addition, the interactive screen game system provides a means for playing the interactive game in a portion of the user television equipment. The game may appear in a portion of the user television equipment when a program is being broadcast or during commercial breaks.

Alternatively, the game may be implemented directly onto user television equipment together with an electronic program guide. In such an embodiment, the electronic program guide provides a platform for the interactive screen game.

### BRIEF DESCRIPTION OF THE DRAWINGS

FIG. 1 is a schematic drawing of a known interactive electronic program guide system.

FIG. 2 is a schematic diagram of user television equipment.

FIG. 3 is a front view of an electronic program guide implemented on user television equipment.

FIG. 4 is a front view of an interactive game implemented on a program region of an interactive electronic program guide according to the present invention.

FIG. 5 is a front view of an interactive game implemented on user television equipment according to the present invention.

FIG. 6 is a front view of a content-related interactive game implemented on user television equipment according to the present invention.

FIG. 7 is front view of an interactive game implemented on user television equipment according to the present invention.

FIG. 8 is a flow chart of an interactive game according to the present invention.

FIG. 9 is a front view of an interactive game having an advertisement implemented on user television equipment according to the present invention.

FIG. 10 is a front view of an interactive game having an advertisement order form implemented on user television equipment according to the present invention.

FIG. 11 is a front view of an interactive game providing a choice of different games implemented on user television equipment according to the present invention.

FIG. 12 is a front view of an interactive game according to the present invention appearing on user television equipment.

### DETAILED DESCRIPTION OF THE INVENTION

During television commercial breaks, many viewers check program schedules, surf to different channels, leave the room, or perform other activities unrelated to the current program. It is an object of this invention to keep the viewer interested in the current program and to watch the advertisements associated with the current program. To accomplish this, an interactive screen game system provides a game that household viewers can play at any time, particularly during the commercial break.

For example, the viewer may be provided with the opportunity to play a game which poses trivia question related to the program being viewed. The viewer would be awarded points. Thus, when the program goes to a commercial break, the viewer is encouraged to continue viewing the channel in which the program is being viewed, rather than changing the channel or performing activities unrelated to the program.

Preferably, when the game is being played, the video and audio from the program are allowed to pass, so that the viewer can monitor when to return to watching. This also allows for the viewer to view the commercials at the same time he is playing the game. Thus, any commercials are preferably not blocked, thereby avoiding alienation of advertisers. The viewer may also be able to finish a turn after the commercial ends, because most of the video may be visible. In fact, because it discourages viewers from channel surfing or bringing up full screen overlays, the invention should appeal to advertisers. These goals may be obtained by overlaying the game graphics over a small portion of the screen. Alternatively, it may be obtained by shrinking the video to partial screen size and locating the game graphics outside the video window. In another embodiment, the game may fill the entire screen, while allowing just the audio to pass.

The game is preferably user-activated. For example, the viewer might press a PLAY key on the remote to begin play, and an EXIT key on the remote to end play. If multiple games are offered, the viewer should be given a simple choice, and the content-related game may preferably be the default choice.

User input to the game may preferably be input from a remote control. A small number of keys on the remote control may preferably be used, such as the cursor keys or the number keys. In the trivia example, these keys may be used to select a single one of a multiple choice of answers.

Because there are likely to be multiple viewers of a program within a household, the game may preferably be multi-player. This might be accomplished by allowing the viewers to pass the remote control between themselves after each turn. Different players might signal their game responses by pressing player-specific keys. Alternatively, it may be accomplished by providing separate remote controls to each player. Each remote may provide its own signature, recognized by the game.

A multi-player game may preferably be such that individual turns are time-limited. As in a single-player game, a multi-player game should also be structured to allow play to be suspended during the program and resumed during the commercial breaks.

In addition, the game may preferably be scored. In that case, the household members should be allowed to define game players, possibly being allowed to enter names. Scores may be accumulated over multiple plays. Scores and player names should preferably be stored in nonvolatile memory.

As mentioned above, the game is preferably related to the current programming. This maintains the viewer's interest in the program, and makes the game more relevant. In the trivia example, the game may have questions related to several popular shows. If one of those programs is currently being watched, the game would present the related questions. If none of those programs is being watched, the guide would present generic questions. Other suitable types of games may also be provided (i.e., a car game, a rocket ship game, or a shooting game).

Space may be allocated on the game screen for advertisements, which may change during the game. In addition, aspects of the game itself may be sponsored. For example, the programmer may provide trivia questions and answers from a program data source by way of the cable television headend.

If a return path to the data source is supported, the game may provide regional or national championships. The highest scores of a game related to a particular program can be tabulated at some pre-determined interval, and the champion of a certain content-related area can be determined. Such an embodiment serves to heighten interest in a particular show.

In one embodiment of the invention, the game may be implemented on an interactive electronic program guide.

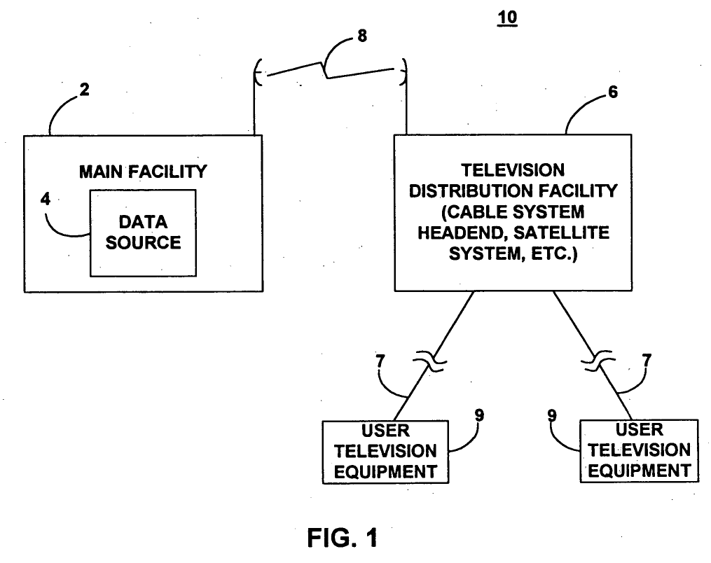

An illustrative arrangement for an interactive electronic television program guide system 10 with the ability to provide an interactive screen game system in accordance with the present invention is shown in FIG. 1. Main facility 2 provides data from data source 4 to distribution facility 6 via communications link 8. Link 8 may be a satellite link, a telephone network link, a cable or fiber optic link, a microwave link, a combination of such links, or any other suitable communications path. If it is desired to transmit video signals over link 8 in addition to data signals, a relatively high bandwidth link such as a satellite link may generally be preferred to a relatively low bandwidth link such as a telephone line. Distribution facility 6 may be a cable system headend, a broadcast distribution facility, or a satellite television distribution facility.

The program guide data transmitted by main facility 2 to distribution facility 6 includes interactive screen game data as well as television program listings data (e.g., program times, channels, titles), program descriptions data and data for other program guide services. If desired, some data may be provided using data sources at facilities other than main facility 2.

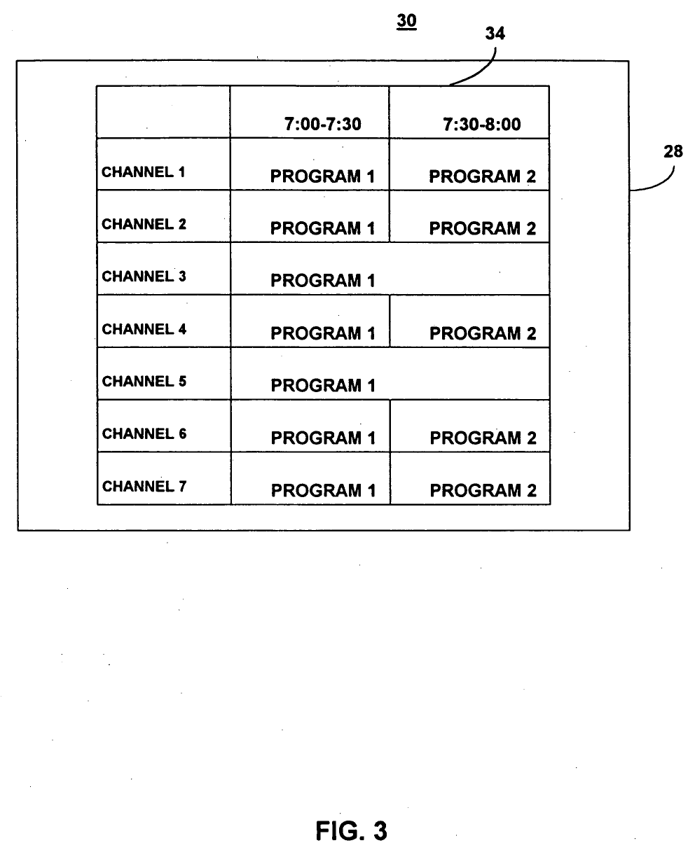

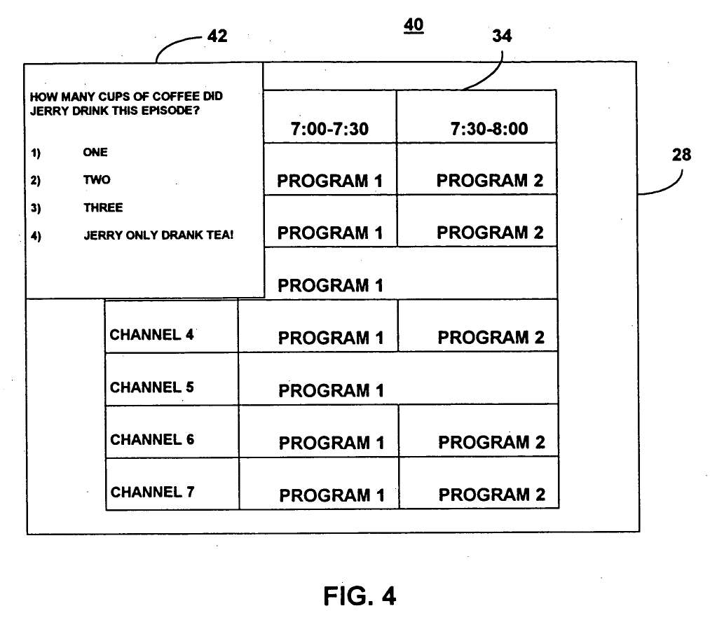

Distribution facility 6 distributes screen game and program guide data and data for other services to multiple users via communications paths 7. Each user has user equipment 9 for displaying an interactive screen game having an interactive game screen 42 (See FIG. 4), television programs, television program listings, program descriptions, and information for other services using an interactive television program guide (See FIG. 3). Many features of the interactive screen game are provided by executing instructions with a microprocessor or similar control circuitry within user equipment 9. Communications paths 7 preferably have sufficient bandwidth to allow distribution facility 6 to distribute television programming and other video information to user equipment 9. An interactive screen game, television programming and video information may also be distributed by distribution facility 6 over communications paths separate from communications paths 7.

Certain program guide functions may require user equipment 9 to transmit return data to distribution facility 6 over communications paths 7 (e.g., with a cable modem, telephone modem, or other suitable return link). If desired, return data may be transmitted over separate communications paths (not shown).

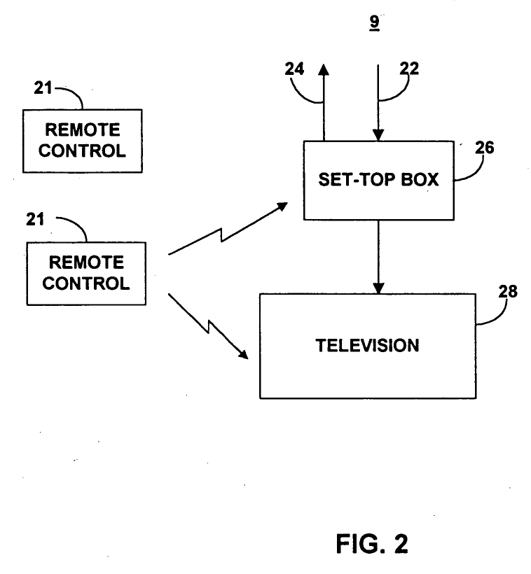

An illustrative arrangement for user equipment 9 is shown in FIG. 2. The interactive screen game may be implemented on user television equipment by itself. Alternatively, the interactive screen game may be implemented by way of an electronic program guide (See FIGS. 3 and 4) resident in set-top box 26. The program guide may coordinate the display of interactive game screen 42, television programs, and television program listings information in television 28. If desired, user television equipment 9 may include a videocassette recorder (not shown) controlled by the program guide on set-top box 26 for recording selected programs.

Periodically, user equipment 9 of FIG. 2 receives interactive game data, television programming, video information, television program listings information, and other data from television distribution facility 6 of FIG. 1 (or from a separate data stream) at input 22. Information from the user may be transmitted to distribution facility 6 of FIG. 1 via output 24. During normal television viewing, the user tunes set-top box 26 to a desired television channel. Remote control 21 or some other suitable user input device such as a mouse, keyboard, touch pad, voice recognition system, etc. may be used for interacting with interactive screen game and controlling set-top box 26 and television 28.

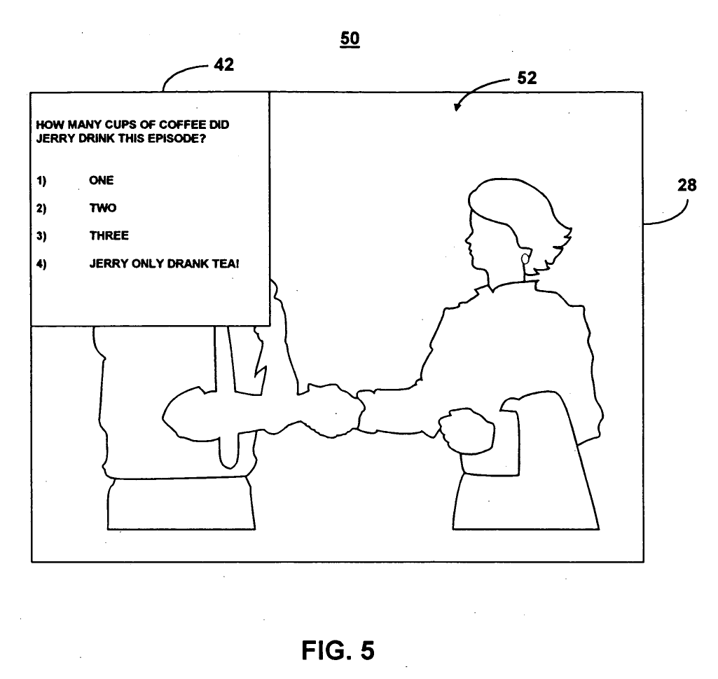

In one embodiment of the invention, interactive game screen 42 appears in a portion of television 28, as shown in FIG. 4. Interactive game screen 42 may overlay a portion of the electronic program guide screen 34, as shown in FIG. 4, or a program or commercial, as shown in FIG. 5.

In a preferred embodiment of the invention, the interactive screen game may relate to the content of the program being shown on television 28. An example of this is shown in FIG. 5. FIG. 5 shows a television program 52 during a commercial break. The opportunity may then be provided to open and play the interactive screen game. The data in the interactive screen game may preferably relate to the content of the portion of the show just observed.

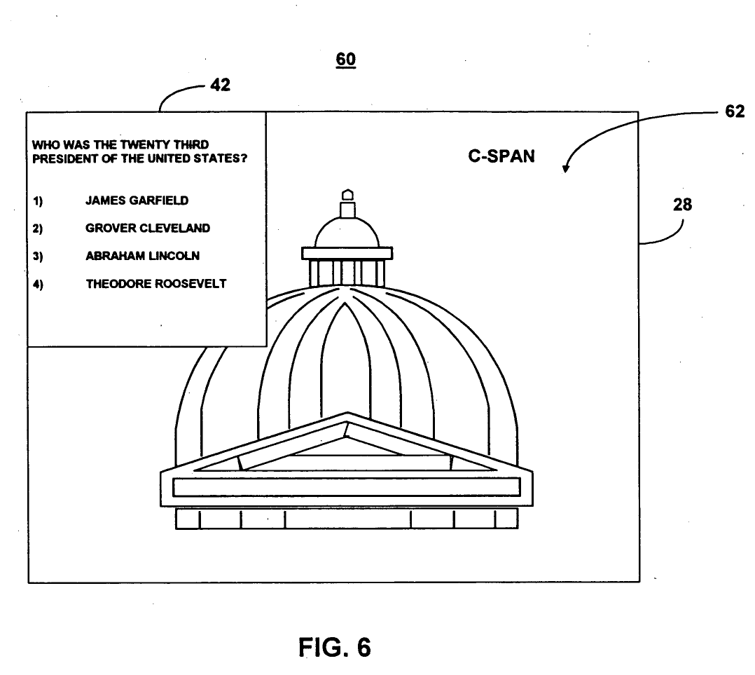

Alternatively, as shown in FIG. 6, an opportunity may be provided to open and play the interactive screen game during the program 62 itself. The trivia game may relate to the general genre of program 62, without relating to the actual subject matter shown in program 62.

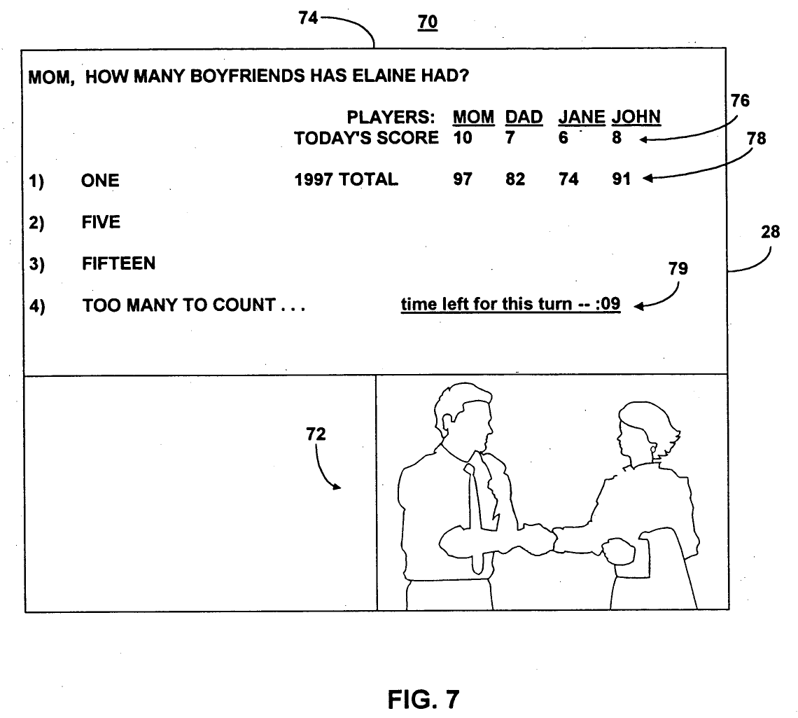

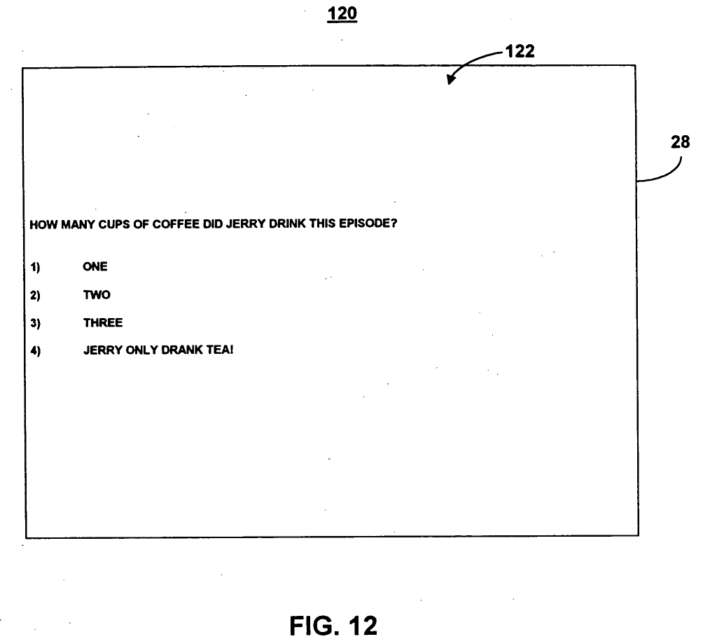

In one embodiment of the invention, as shown in FIG. 7, the dimensions of interactive game screen 74 may be adjustable. In addition, the dimensions of the television image 72 may be adjustable as well. This feature provides an opportunity to adjust the viewing of both the program or commercial and the interactive screen game. In one embodiment of the invention, as shown in FIG. 12, interactive game screen 122 may be enlarged such that it fills the entire television. In such an embodiment, audio from the screen may still preferably be allowed to pass.

In one embodiment of the invention, multi-player games may be offered, as shown in FIG. 7. Each player may be provided with an individual remote control 21, as shown in FIG. 2. In addition, game scores 76, 78 for each player can be recorded for each day, year, or for some other suitable time period. If a return path for game scores 76, 78 is provided, i.e., along communication paths 7 shown in FIG. 1, regional and national championships can be held for the games. The time for each individual turn may be controlled by a timer 79.

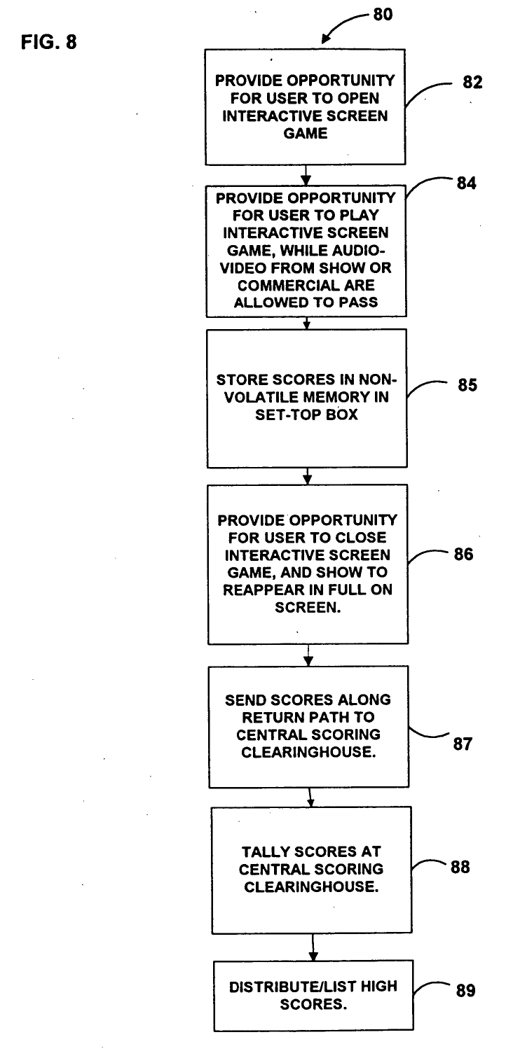

A flow chart for one example of a system providing a return path is shown in FIG. 8. In box 82, an opportunity is provided to open the interactive screen game. In box 84 an opportunity is provided to play the interactive screen game in a portion of a television while audio and video from a commercial or a program are allowed to pass. Box 85 indicates that scores are preferably stored in non-volatile memory for access at a later time. Once the game is closed, as shown in box 86, return scores may preferably be sent along a return path to a central scoring clearing house, as shown in box 87. In one embodiment, scores may be retained in the set-top box for future games. As shown in box 88, the scores are tallied at the central scoring clearinghouse, and high scorers can be determined. Finally, the scores can be listed on the program guide or distributed to individual users in some suitable fashion, as shown in box 89.

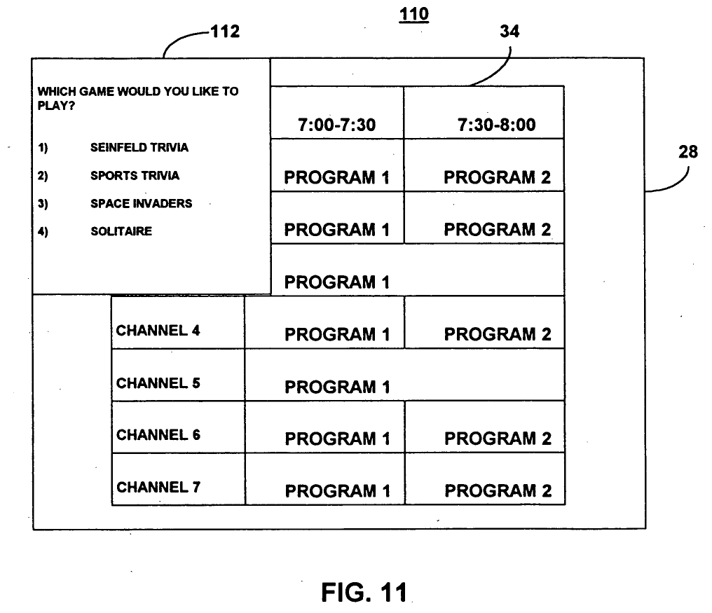

A choice of different games, as shown in FIG. 11 may also be available to a user. The different games 112, as shown in FIG. 11, may relate to the content of a program or commercial being viewed, or be unrelated video games.

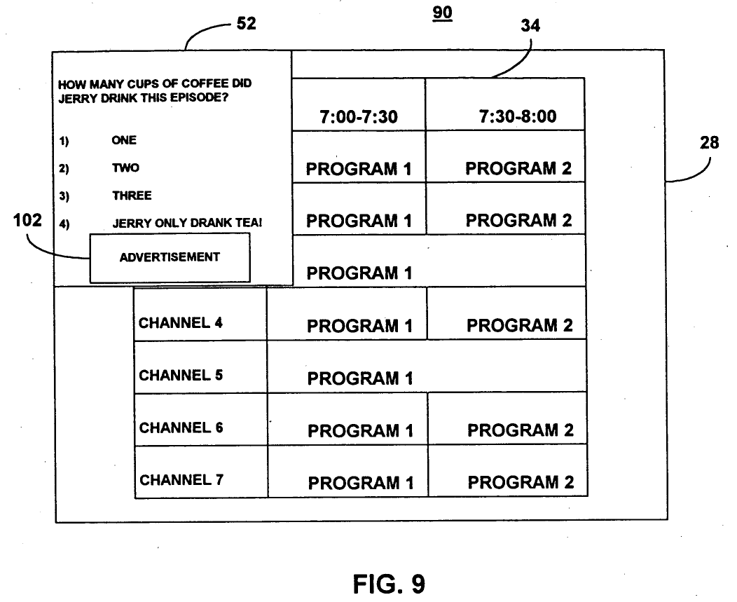

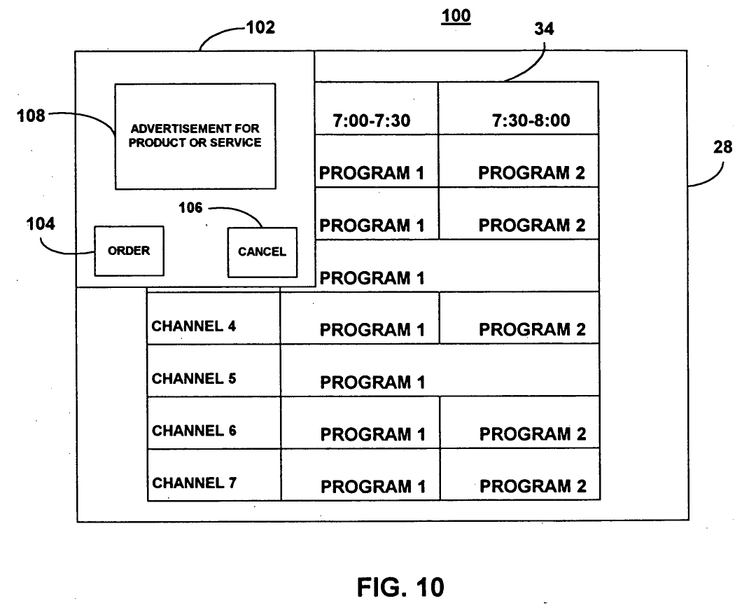

In another embodiment of the invention, advertisements 102 may be shown within interactive game screen 42, as shown in FIG. 9. The advertisements may be accessed such that a form 102 for performing actions related to a product (i.e., to order a product, to advertise a television program, show a preview of an upcoming motion picture, etc.) is available as well, as shown in FIG. 10. Form 102 may included an advertisement space 108, a space to order 104, a space to cancel advertisement screen 106, or perform some other suitable action related to the advertised product (i.e., to restrict a product such as parents restricting an adult television service, etc.) Similar advertising options are described in co-pending commonly-assigned U.S. patent application Ser. No. 09/034,939, entitled “Program Guide System with Targeted Advertising”, which is hereby incorporated by reference. These choices may be accessed by the remote control or some other suitable device.

One skilled in the art will appreciate that the present invention can be practiced by other than the described embodiments, which are presented for purposes of illustration and not of limitation, and the present invention is limited only by the claims which follow.

What is claimed is:

1. An interactive electronic program guide system comprising:
user television equipment for displaying a television program, said user television equipment producing an audio output and a video output;
an interactive electronic program guide implemented on said user television equipment, said interactive electronic program guide having an interactive electronic program guide screen; and
means for playing an interactive screen game, said means for playing said interactive screen game being implemented by said program guide, said means for playing displaying an interactive game screen as an overlay on top of said video output.

2. The interactive electronic program guide system defined in claim 1, wherein said means for playing said interactive screen game further comprises providing an interactive screen game for use by at least two users.

3. The interactive electronic program guide system defined in claim 2, wherein said means for playing said interactive screen game further comprises means for providing an individual remote control to at least two users.

4. The interactive electronic program guide system defined in claim 3, wherein the image of said program on said user television equipment may be reduced.

5. The interactive electronic program guide system defined in claim 1, wherein said interactive game screen overlays a portion of said interactive television program guide screen.

6. The interactive electronic program guide system defined in claim 5, wherein the size and location of said interactive game screen may be adjusted.

7. The interactive electronic program guide system defined in claim 5, wherein the size and location of said video output may be adjusted.

8. The interactive electronic program guide system defined in claim 1, wherein said means for playing said interactive screen game further comprises means for including an advertisement within said game screen.

9. The interactive electronic program guide system defined in claim 8, wherein said means for playing an advertisement comprises a means for performing an action related to an advertised object.

10. The interactive electronic program guide system defined in claim 1, wherein said means for playing said interactive screen game occupies the entirety of said user television equipment, thereby restricting said video output from passing, but allowing said audio output to pass.

11. The interactive electronic program guide system defined in claim 1, wherein data for said means for playing said interactive screen game is supplied by a data source.

12. The interactive electronic program guide system defined in claim 1, wherein said means for playing said interactive screen game is user activated.

13. The interactive electronic program guide system defined in claim 1, wherein content of said means for playing said interactive screen game reflects content of said program appearing on said user television equipment.

14. The interactive electronic program guide system defined in claim 1, wherein said means for playing said interactive screen game further comprises a means for controlling the time of an individual game turn.

15. The interactive electronic program guide system defined in claim 1, wherein said means for playing said interactive screen game further comprises a means for keeping score.

16. The interactive electronic program guide system defined in claim 1, wherein said means for playing said interactive screen game further comprises a means for storing cumulative score.

17. The interactive electronic program guide system defined in claim 16, wherein said means for storing cumulative score further comprises a means for storing cumulative score in non-volatile memory.
